(19) United States
(12) Patent Application Publication
(10) Pub. No.: US 2016/0110466 A1
(43) Pub. Date: Apr. 21, 2016

(54) SYSTEM AND METHOD FOR RANKING NAMED-DATA NETWORKING OBJECTS IN A CACHE

(71) Applicant: Palo Alto Research Center Incorporated, Palo Alto, CA (US)

(72) Inventor: Ersin Uzun, Campbell, CA (US)

(21) Appl. No.: 14/516,450

(22) Filed: Oct. 16, 2014

(51) Int. Cl. G06F 17/30

(52) U.S. Cl. CPC G06F 17/30876; G06F 17/30902

(57) ABSTRACT

A router can select a cached Content Object to rank, and analyzes historical usage information for the Content Object to determine a set of exclusions received for the Content Object. The router then computes a rank value for the Content Object, based on the set of exclusions for the Content Object and one or more predetermined exclusion patterns, and stores the rank value in association with the Content Object. When the router receives an Interest whose name is associated with multiple cached Content Objects, the router selects, from the multiple cached Content Objects, a cached Content Object with a highest rank value. The router can return the selected cached Content Object to satisfy the Interest.

### RELATED APPLICATION

The subject matter of this application is related to the subject matter of the following applications:
U.S. patent application Ser. No. 12/338,175 (Atty. Docket No. PARC-20080626-US-NP), entitled “CONTROLLING THE SPREAD OF INTERESTS AND CONTENT IN A CONTENT CENTRIC NETWORK,” by inventors Van L. Jacobson and Diana K. Smetters, filed 18 Dec. 2008; and
U.S. patent application Ser. No. 13/847,814 (Atty. Docket No. PARC-20120537-US-NP), entitled “ORDERED-ELEMENT NAMING FOR NAME-BASED PACKET FORWARDING,” by inventor Ignacio Solis, filed 20 Mar. 2013;
   the disclosures of which are incorporated by reference in their entirety herein.

This invention was made with U.S. Government support under Contract No. CNS-1040822 awarded by the National Science Foundation (NSF) Future Internet Architectures (FIA) program, Named Data Networking (NDN) project. The U.S. Government has certain rights in this invention.

### BACKGROUND

1. Field

This disclosure is generally related to named data networking (NDN). More specifically, this disclosure is related to ranking Content Objects in a cache.

2. Related Art

The proliferation of mobile computing and cellular networks is making digital content more mobile than ever before. People can use their smartphones to generate content, to consume content, or even to provide Internet access to other computing devices that generate or consume content. Oftentimes, a device's network location can change as a person takes this device to a new physical location. This can make it difficult to communicate with this device under a traditional computer network (e.g., the Internet) when the device's new network location is not known.

To solve this problem, information centric network (ICN) architectures have been designed to facilitate accessing digital content based on its name, regardless of the content's physical or network location. Named data networking (NDN) is one example of an Information Centric Networking (ICN). Unlike traditional networking, such as Internet Protocol (IP) networks where packets are forwarded based on an address for an end-point, the NDN architecture assigns a routable name (e.g., an address) to content itself so the that content can be retrieved from any device that hosts the content.

A typical NDN architecture forwards two types of packets: Interests and Content Objects. Interests include a name for a piece of named data, and serve as a request for the piece of named data. Content Objects, on the other hand, typically include a payload, and are only forwarded along a network path that has been traversed by an Interest with a matching name, and traverse this path in the reverse direction taken by the Interest packet. Typical NDN architectures only send Content Objects as a response to an Interest packet; Content Objects are not sent unsolicited.

NDN architectures can ensure content authenticity by allowing publishers to sign content, which allows consumers to verify content signatures. However, typical NDN routers do not perform content signature verification on Content Objects to avoid incurring additional network latency. Some NDN routers also maintain a Content Store that caches content to minimize the round-trip-delay, by returning a cached Content Object whenever possible. However, content caching in routers opens the door for denial-of-service (DoS) attacks.

One such DoS attack involves content poisoning, where an adversary injects fake content into a router's cache to flood the NDN network with fake content that blocks access to legitimate content of the same name. Although consumers can detect fake content by performing signature verification, a typical NDN architecture does not search for fake content to remove from cache.

Clients can avoid becoming victim to content poisoning attacks by enforcing the use of self-certifying content names. The client can issue Interests that refer to content by its full name, including its hash. However, this is only possible if the client knows the content's hash value ahead of time. The client may not be able to enforce use of self-certifying names for dynamically-generated content that can change frequently (e.g., a web page that's updated every minute), since any change in its content results in a new hash for the content.

### SUMMARY

One embodiment provides a router that can select a Content Object to rank, and analyzes historical usage information for the Content Object to determine a set of exclusions received for the Content Object. The Content Object can include a cached Content Object stored in a local cache or Content Store. The router then computes a rank value for the Content Object, based on the set of exclusions for the Content Object and one or more predetermined exclusion patterns, and stores the rank value in association with the Content Object.

In some embodiments, the router belongs to a named data network (NDN), which is an example of an information centric network (ICN). In ICN (and NDN), each piece of content is individually named, and each piece of data is bound to a unique name that distinguishes the data from any other piece of data, such as other versions of the same data or data from other sources. This unique name allows a network device to request the data by disseminating a request or an Interest that indicates the unique name, and can obtain the data independent from the data's storage location, network location, application, and means of transportation. The following terms describe elements of an NDN architecture:

Content Object:

A single piece of named data, which is bound to a unique name. Content Objects are “persistent,” which means that a Content Object can move around within a computing device, or across different computing devices, but does not change. If any component of the Content Object changes, the entity that made the change creates a new Content Object that includes the updated content, and binds the new Content Object to a new unique name.

Unique Names:

A name in an NDN is typically location independent and uniquely identifies a Content Object. A data-forwarding device can use the name or name prefix to forward a packet toward a network node that generates or stores the Content Object, regardless of a network address or physical location for the Content Object. In some embodiments, the name may be a hierarchically structured variable-length identifier (HSVLI). The HSVLI can be divided into several hierarchical components, which can be structured in various ways. For example, the individual name components parc, home, ndn, and test.txt can be structured in a left-oriented prefix-major fashion to form the name “/parc/home/ndn/test.txt.” Thus, the name “/parc/home/ndn” can be a “parent” or “prefix” of “/parc/home/ndn/test.txt.” Additional components can be used to distinguish between different versions of the content item, such as a collaborative document.

In some embodiments, the name can include an identifier, such as a hash value that is derived from the Content Object's data (e.g., a checksum value) and/or from elements of the Content Object's name. A description of a hash-based name is described in U.S. patent application Ser. No. 13/847,814 (entitled “ORDERED-ELEMENT NAMING FOR NAME-BASED PACKET FORWARDING,” by inventor Ignacio Solis, filed 20 Mar. 2013), which is hereby incorporated by reference. A name can also be a flat label. Hereinafter, “name” is used to refer to any name for a piece of data in a name-data network, such as a hierarchical name or name prefix, a flat name, a fixed-length name, an arbitrary-length name, or a label (e.g., a Multiprotocol Label Switching (MPLS) label).

Interest:

A packet that indicates a request for a piece of data, and includes a name (or a name prefix) for the piece of data. A data consumer can disseminate a request or Interest across an information-centric network, which NDN routers can propagate toward a storage device (e.g., a cache server) or a data producer that can provide the requested data to satisfy the request or Interest.

In some embodiments, the NDN or ICN system can include a content-centric networking (CCN) architecture. However, the methods disclosed herein are also applicable to other ICN architectures as well. A description of a CCN architecture is described in U.S. patent application Ser. No. 12/338,175 (entitled “CONTROLLING THE SPREAD OF INTERESTS AND CONTENT IN A CONTENT CENTRIC NETWORK,” by inventors Van L. Jacobson and Diana K. Smetters, filed 18 Dec. 2008), which is hereby incorporated by reference.

In some embodiments, the router selects the Content Object to rank in response to storing the Content Object in a cache, receiving an Interest whose name matches a name or name prefix of the Content Object, or receiving an Interest that includes an exception for the Content Object.

In some embodiments, the router receives an Interest whose name is associated with multiple cached Content Objects, and selects, from the multiple cached Content Objects, a cached Content Object with a highest rank value. The router then returns the selected cached Content Object to satisfy the Interest.

In some embodiments, the router can determine that the Content Object is a new Content Object, and assigns a maximum rank value to the Content Object. The router can determine that the Content Object is a new Content Object, for example, by determining that the Content Object has not been returned to satisfy an Interest, and/or determining that an exclusion has not been received for the Content Object.

In some embodiments, the router selects one or more exclusion patterns for ranking the Content Object from a set of predetermined exclusion patterns. The set of predetermined exclusion patterns can include an exclusion-rate pattern, a time distribution pattern, and/or an excluding-interfaces pattern. The exclusion-rate pattern ranks the Content Object based on a rate at which the Content Object received exclusions. The time distribution pattern ranks the Content Object based on a time elapsed since the Content Object received an exclusion. The excluding-interfaces pattern that ranks the Content Object based on a fraction of local interfaces from which the Content Object received exclusions.

In some embodiments, while computing the rank value, the router computes a factor for each exclusion pattern, based on the set of exclusions for the Content Object. The router then computes an overall factor, F, based on the individual factors for each exclusion pattern, and computes the rank value using the overall factor, F.

In some variations on these embodiments, while computing the rank value, the router computes:

$${r}_{n \vert H ( C )} ( t ) = {e}^{\frac{- t}{F}}$$

Here, r_{n|H(C)} designates the rank value for the Content Object, and t designates the age of the Content Object in the cache.

### BRIEF DESCRIPTION OF THE FIGURES

FIG. 1 illustrates an exemplary network environment that facilitates selecting a highest-ranking cached Content Object to satisfy an Interest in accordance with an embodiment.

FIG. 2A illustrates an exemplary Interest in accordance with an embodiment.

FIG. 2B illustrates an exemplary Content Object in accordance with an embodiment.

FIG. 3 presents a flow chart illustrating a method for processing an Interest in accordance with an embodiment.

FIG. 4 presents a flow chart illustrating a method for updating a Content Object's rank value in accordance with an embodiment.

FIG. 5 presents a flow chart illustrating a method for computing a rank value for a cached Content Object in accordance with an embodiment.

FIGS. 6A-6B illustrate rank values for a set of exemplary Content Objects in accordance with an embodiment.

FIG. 7 illustrates an exemplary apparatus that facilitates selecting a highest-ranking cached Content Object to satisfy an Interest in accordance with an embodiment.

FIG. 8 illustrates an exemplary computer system that facilitates selecting a highest-ranking cached Content Object to satisfy an Interest in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a content-caching system that solves the problem of thwarting content poisoning attacks in NDN by providing a statistical content-ranking algorithm for router caches. The system computes rank values for cached Content Objects based on statistics collected from existing fields of Interest packets, and does not require any changes to the NDN architecture.

In a content poisoning attack, an adversary (e.g., a malicious entity) attempts to perform a denial-of-service (DoS) attack by “poisoning” a router's cache with fake content. Valid Content Objects contain a verifiable signature produced with the correct public key. Hence, a typical client device can detect a fake Content Object when the Content Object has an invalid signature (e.g., the signature verification algorithm returns an error), has a valid signature which is generated (signed) with the wrong key (e.g., not signed using the key of the purported producer), or has a mal-formed signature field. However, typical routers do not perform signature verification at line speed, as doing so would burden the router's processing resources by utilizing them to fetch, parse and verify public keys. Also, since trust is always application-dependent, it is not necessary for routers (especially backbone routers) to be involved in the specifics of trust management. Adversaries attempt to exploit this lack of verification across NDN routers to block access to real data by causing many of these routers to cache and serve fake versions of this content.

In some embodiments, a router's cache can include multiple Content Objects that can satisfy an Interest, especially during a poisoning attack. In this situation, it is possible that the router may return a fake Content Object, even when a legitimate Content Object exists in the cache. If the client does receive a fake Content Object, the client may re-issue the Interest for the Content Object, but this time identifying the fake Content Object in an “exclude” field of the Interest. The client may also re-issue the Interest to exclude an unsatisfactory Content Object, even though the Content Object carries otherwise valid content. The content-caching system can use the exclude field to avoid returning Content Object that the client knows it does not want.

In some embodiments, the content-caching system analyzes the exclusions received for a cached Content Object against one or more exclusion patterns to rank the cached Content Object, and does so to rank valid Content Objects higher that fake or unsatisfactory Content Objects. This allows the router to best satisfy an Interest when multiple matching Content Objects exist in the cache, without validating the Content Object, by returning a Content Object with a highest rank value.

Hereinafter, the term “fake” or “fake content” refers to Content Objects injected by a malicious entity. An “adversary” is a malicious NDN entity (or a collaborating group of malicious entities) capable of injecting content into the network. “Content poisoning” describes an attack where an adversary injects fake content into router caches at one or more NDN routers. Also, an “unsatisfactory” Content Object is an otherwise valid Content Object that does not satisfy the consumer's needs.

In some embodiments, the content-caching system can assign each new Content Objects a maximum rank value (e.g., the rank value of 1), and, as time elapses, this rank value may gradually decrease. This gives priority to newer cached content over older content. In addition, the rank of a specific Content Object can depend on the number of times it was excluded, and its time distribution. For example, the content-caching system can assign a lower rank to Content Objects with many recent exclusions, than to a Content Object with fewer and older exclusions. This safeguards against blocking less-desirable, yet valid, Content Objects that may receive few exclusions over time from clients that are not satisfied with the Content Object's content or version (e.g., an older content version). On the other hand, the content-caching system can penalize a Content Object which has been excluded by Interests arriving on multiple interfaces, as such a scenario indicates a higher likelihood of there being something wrong with the Content Object.

### Exemplary Network Environment

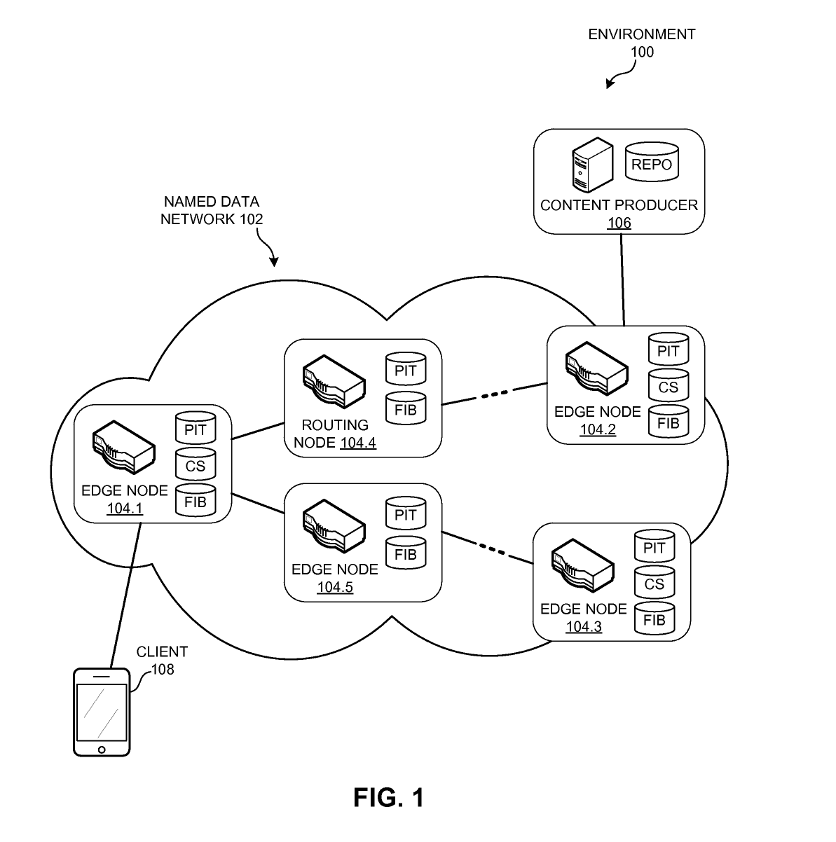

FIG. 1 illustrates an exemplary network environment 100 that facilitates selecting a highest-ranking cached Content Object to satisfy an Interest in accordance with an embodiment. Specifically, network environment 100 can include a named data network (NDN) 102 whose member devices can include a content producer 106, a personal computing device 108, and one or more NDN routing nodes 104 that can forward Interests and Content Objects across NDN 102.

Unlike Internet Protocol (IP) networks where packets are forwarded based on a network address for an end-point of communication, NDN 102 forwards Interest packets based on a name for a piece of content, regardless of which end-point device hosts the content. There are two types of packets in NDN: Interests and Content Objects. NDN communication adheres to the pull model, where a Content Object is delivered to consumers upon an explicit request. The terms Content Object, content packet, and content are hereinafter used interchangeably.

Hence, NDN 102 does not forward packets based on a destination address for an endpoint. Rather, any NDN node (e.g., content producer 106) can host and serve Content Objects. Producer-originated content signatures allows client 108 to authenticate a received Content Object, regardless of the NDN node that served this Content Object. As mentioned above, consumers must verify content signatures, while routers may forego signature verification that can be computationally expensive.

Client 108 (e.g., a content consumer) can request a Content Object by issuing an Interest packet that specifies a name or name prefix for the Content Object. The content name is composed of one or more variable-length name components that are opaque to the network. If an NDN node stores or can produce a Content Object that “satisfies” the Interest, this NDN node returns the Content Object. However, if a routing node 104 receives a Content Object with a name n when no pending Interest exists for that name, the routing node interprets the Content Object as “unsolicited” and discards the Content Object.

Content producer 106 can include any device that produces and publishes (as well as signs) content, and client 108 (e.g., a consumer) can include any device that issues an Interest for content. Routing nodes and edge nodes 104 can include any router that routes an Interest toward a content producer associated with the Interest's name, and forwards a corresponding Content Object toward a client that disseminated the Interest. Note that content producer 106 and/or client device 108 can be any type of a computing device, including a mobile computing device, such as a laptop computer, a tablet or slate computer, a smartphone, or a personal digital assistant (PDA), or a stationary computing device, such as a desktop computer or a home media server.

In some embodiments, CCN nodes 104 can include and a forwarding information base (FIB) and a pending Interest table (PIT). The FIB includes a routing table of name prefixes and corresponding outgoing interfaces that can be used to forward Interests. The PIT includes a table of outstanding (pending) Interests, and a set of corresponding incoming and outgoing interfaces associated with these Interests. Also, some CCN nodes (e.g., edge nodes 104.1-104.3) can include a cache or Content Store (CS) for caching Content Objects that can be used to satisfy Interests. A CS cache size for a routing node 104 depends on the resources available at routing node 104. Each routing node 104 independently determines what content to cache and for how long. In some embodiments, a Content Object can include a “freshness” field that specifies a timeout for the cached Content Object, which the CS can use to determine when to evict the Content Object. Upon receiving an Interest, the routing node first checks its CS to determine whether the routing node can satisfy this Interest locally.

Content producer 106, on the other hand, may include a FIB and a PIT, and a repository that stores (e.g., persistently or for a long-term period) a collection of Content Objects hosted by content producer 206. Device 108 may include a FIB and a PIT, and may include a CS as well as one or more repositories for storing persistent Content Objects.

In some embodiments, a malicious entity may attempt to perform a content poisoning attack across NDN 102 by anticipating the name, n, for Interests disseminated by client 108. This malicious entity may inject face content of name n at edge node 104.1 to prevent edge node 104.1 from returning a valid Content Object from the local CS, and to prevent edge node 104.1 from forwarding the Interest toward content producer 106 when a valid matching Content Object does not exist in the CS. The malicious entity can inject fake content into the network via compromised routers or other malicious/compromised nodes. For example, an adversary may consist of a malicious consumer Cₘ and a malicious producer Pₘ that have targeted a specific router 104.1, such that Cₘ and Pₘ may be connected to different interfaces of router 104.1. To perform the attack, malicious consumer Cₘ sends an Interest having name n, and once router 104.1 receives this Interest and creates a PIT entry for the Interest, producer Pₘ sends a fake Content Object to router 104.1 which is promptly cached. As a consequence, router 104.1 is pre-polluted with fake content, ready for the arrival of genuine Interests. Malicious producer Pₘ may set the freshness of the fake content to a maximum value to maximize longevity of the attack.

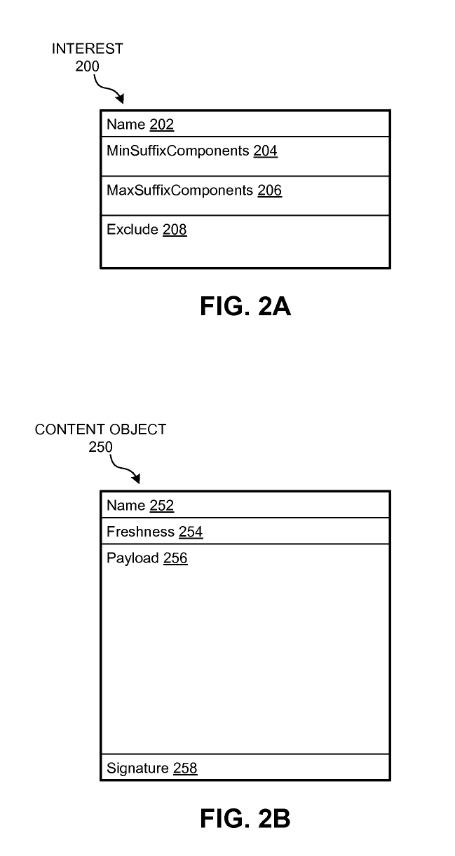

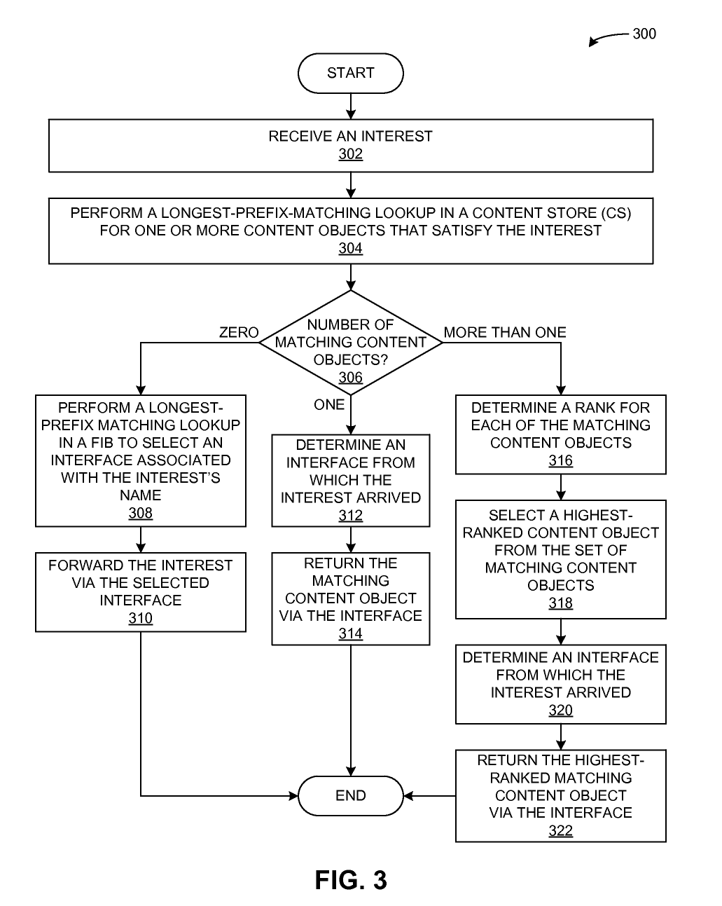

FIG. 2A illustrates an exemplary Interest 200 in accordance with an embodiment. Specifically, Interest 200 can include at least a Name field 202, a MinSuffixComponents field 204, a MaxSuffixComponents field 206, and an Exclude field 208. Name field 202 includes a name or name prefix for a Content Object or a collection of content, comprising a sequence of explicit name components. Name field 202 can also include an implicit digest component (e.g., a hash value) of a desired Content Object, which effectively provides a unique name for the desired Content Object. However, the digest component does not need to be present in some Interest packets, since NDN does not provide consumer nodes with a secure mechanism to learn a Content Object's hash before generating or disseminating an Interest for the Content Object.
MinSuffixComponents 204 specifies a minimum number of name components, beyond those specified in the name, that are allowed to occur in a matching Content Object. MaxSuffixComponents 206 specifies a maximum number of name components, beyond those specified in the name, that are allowed to occur in matching content. The MinSuffixComponents 204 and MaxSuffixComponents 206 fields facilitate performing a longest-prefix matching lookup.

Exclude field 208 contains information about name components that must not occur in the name of returned Content Object. In some embodiments, exclude field 208 can be used to exclude a certain Content Object based on its hash, which is considered to be an implicit, last component of each content name.

FIG. 2B illustrates an exemplary Content Object 250 in accordance with an embodiment. Content Object 250 can include a Name field 252, a Freshness field 254, a Payload 256, and a Signature field 258. Similar to Interest 200, Name 252 includes a name for Content Object 250, comprising a sequence of explicit name components, such as a name prefix for Content Object 250 and a digest of Content Object 250.

Freshness 252 includes a time duration that the content producer recommends that Content Object 250 should be cached. The NDN routers can choose to evict Content Object 250 from cache when it has surpassed the time duration specified in freshness field 252, and/or can choose to evict Content Object 250 using any other local criteria. Payload 256 includes the content associated with name 252.

Signature 258 can include a public key signature, which can be generated by a publisher or content producer of Content Object 250 based on the Content Object 250, including all explicit components of name 250, one or more fields of Content Object 250 (e.g., freshness 254), and payload 256. Signature field 258 can also include a reference to a public key (e.g., referenced by the public key's NDN name) that a consumer can use to verify Content Object 250.

In some embodiments, each producer can have at least one public key, represented as a bona fide named Content Object signed by a trusted entity that issued the public key (e.g., a Certificate Authority (CA)). The name of a public key Content Object typically contains the “key” component as its last explicit component. For example, a key for one or more Content Objects associated with the name prefix “/ndn/GothamGazette/PublishedContent” can be signed by the key with name “/ndn/GothamGazette/PublishedContent/key.” Moreover, in order for signature 258 to be valid (not just verifiable), the name of the public key (the private counterpart of which is used to sign Content Object 250) without the last explicit component needs to form a prefix of Name 252 for Content Object 250. For example, the key “/ndn/GothamGazette/PublishedContent/key” is valid for a Content Object named “/ndn/GothamGazette/PublishedContent/Sports/Headlines,” but is not valid for Content Objects under the name prefix “/ndn/GothamGazette/Paywall/Content/.”

### Ranking Content Objects

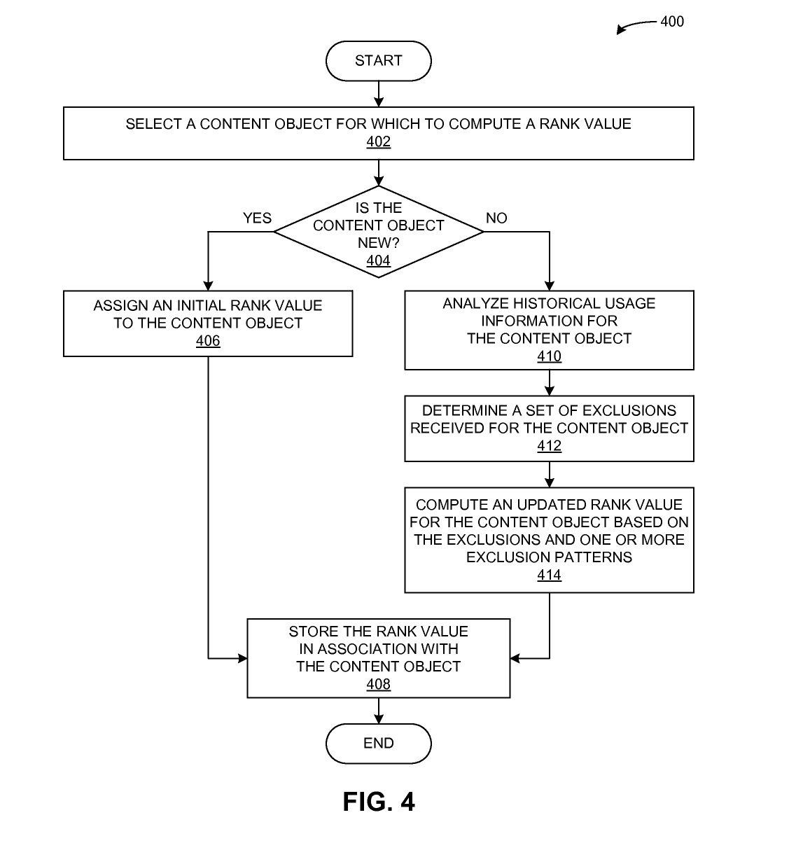

FIG. 3 presents a flow chart illustrating a method 300 for processing an Interest in accordance with an embodiment. During operation, a router (or any NDN device) can receive an Interest, which specifies a name or name prefix for a Content Object (operation 302). The router performs a longest-prefix-matching lookup operation in a local cache or Content Store (CS) to identify one or more Content Objects that satisfy the Interest (operation 304). Multiple matching Content Objects can exist, such as multiple Content Objects with the same name or name prefix, and different payloads. Hence, the router determines the number of matching Content Objects that exist in the cache or CS (operation 306).

If there are no matching Content Objects, the router can forward the Interest across the NDN by performing a longest-prefix-matching lookup in a forwarding information base (FIB) to select an interface associated with the Interest's name (operation 308), and forwards the Interest via the selected face (operation 310). On the other hand, if exactly one matching Content Object exists, the router can return the matching Content Object to satisfy the Interest by determining a face from which the Interest arrived (e.g., by performing a lookup operation in a pending Interest table (PIT)) (operation 312), and returning the matching Content Object via this Interface (operation 314).

However, if multiple matching Content Objects exist, the router makes a determination as to which Content Object may best satisfy the Interest before returning this Interest. For example, the router can determine a rank for each of the matching Content Objects (operation 316), and selects a highest-ranked Content Object from the set of matching Content Objects (operation 318). The router then determines a face from which the Interest arrived (operation 320), and returns the highest-ranked matching Content Object via this Interface (operation 322).

In some embodiments, the router ranks cached Content Objects so that valid Content Objects have a higher rank value than fake or malicious Content Objects. The rank value is a numeric value within a predetermined range, such as the range [0, 1]. All cached content starts with the highest possible value (e.g., a rank value of 1), and can decrease and/or increase within the predetermined range over time. This gives priority to newer cached Content Objects over older Content Objects. In addition, the rank of a specific content depends on one or more exclusion patterns, such as the number of times the Content Object was excluded by an Interest, when it was excluded, and via which interfaces.

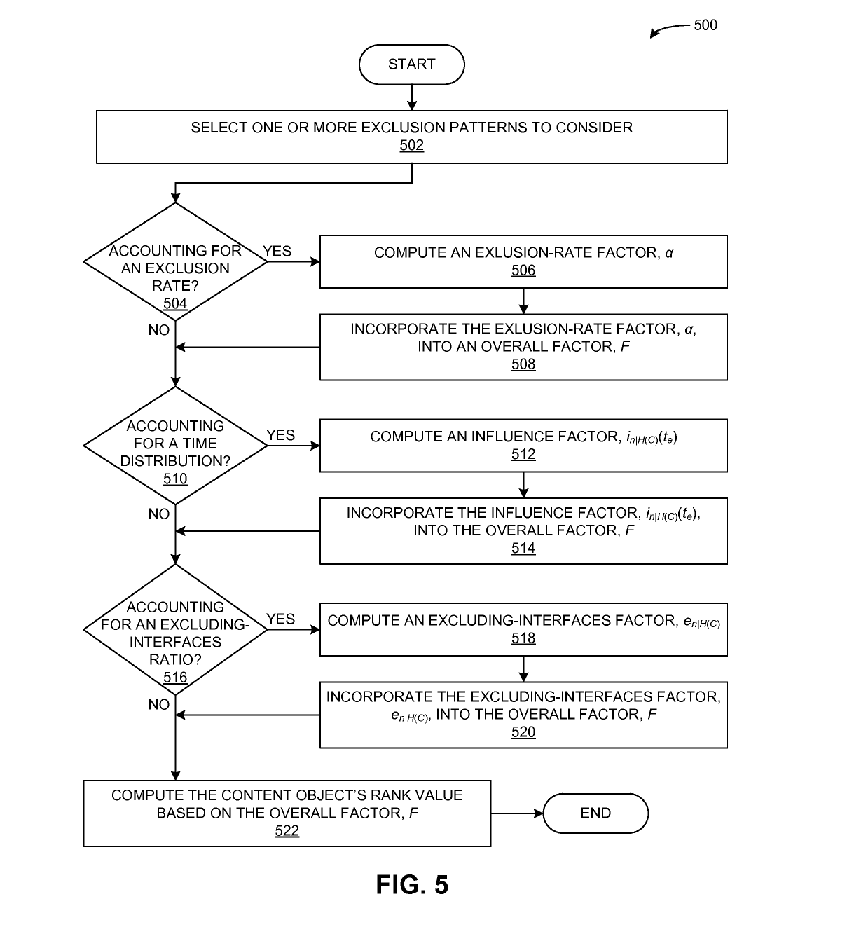

FIG. 4 presents a flow chart illustrating a method 400 for updating a Content Object's rank value in accordance with an embodiment. During operation, the cache-processing system (e.g., a router or any NDN device with a cache) can select a Content Object for which to compute a rank value (operation 402). In some embodiments, each unique Content Object is identified by a combination of the Content Object's name, n, and digest, H(C). Hence, each unique Content Object is hereinafter denoted as the concatenation of the Content Object's name and digest: n|H(C).

The system then determines if this Content Object is a new Content Object (operation 404). In some embodiments, a Content Object, n|H(C), is considered to be new if the Content Object has not been cached in the past, if the current instance (and/or any prior instance) of the Content Object has not been used to satisfy an Interest, and/or if the current instance (and/or any prior instance) of the Content Object has not received an exclusion.

If the Content Object is new, the system assigns a predetermined initial rank value to the Content Object (operation 406). In some embodiments, this predetermined initial rank value is the highest possible rank value in the range of allowable rank values (e.g., the maximum value 1 in the rank value range [0, 1]). The system then stores the rank value, for example, in a database or in a cache (e.g., a Content Store) in association with the Content Object (operation 408).

However, if the Content Object is not new, the system can analyze historical usage information for the Content Object (operation 410), which can include information on the Interests received in the past that include the Content Object's name, from which interfaces these Interests were received, and the exclusions listed in these Interests. The system then determines a set of exclusions received for selected the Content Object (operation 412), such as by selecting the exclusions that explicitly specify the selected Content Object's digest (e.g., a hash value), and ignoring exclusions that do not specify the selected Content Object's digest. In some embodiments, the exclusions are for the current instance of the Content Object. In some variations to these embodiments, the exclusions can also include exclusions received for a prior instance of the same Content Object, such as before or after the prior instance of the Content Object was evicted from the cache or CS.

The system then computes an updated rank value for the Content Object based on the set of exclusions and one or more exclusion patterns (operation 414), and stores the rank value in association with the Content Object (operation 408). In some embodiments, these exclusion patterns can include a number of times the Content Object was excluded within a given time window (e.g., an exclusion rate), a time distribution for these exclusions, and a ratio of the relevant interfaces that have issued an exclusion (e.g., an excluding-interfaces ratio).

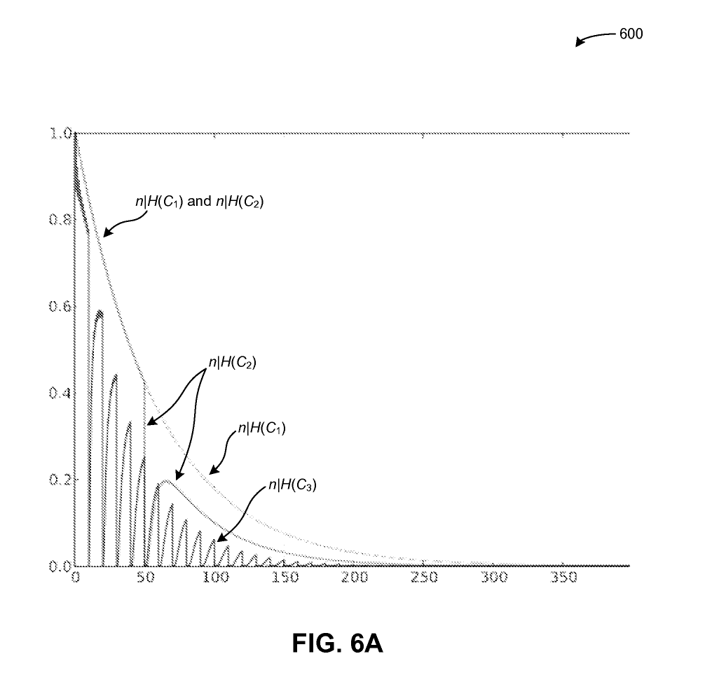

FIG. 5 presents a flow chart illustrating a method 500 for computing a rank value for a cached Content Object in accordance with an embodiment. During operation, the system can select one or more exclusion patterns to consider (operation 502). In some embodiments, the set of possible exclusion patterns can include an “exclusion rate,” a “time distribution,” and an “excluding-interfaces ratio.” The “exclusion rate” pattern accounts for a number of times the Content Object was excluded within a given time window, the “time distribution” pattern accounts for a time distribution for these exclusions, and the “excluding-interfaces ratio) accounts for a ratio of the relevant interfaces that have issued an exclusion.

If the system is accounting for an exclusion rate (operation 504), the system computes an exclusion-rate factor, a, for the Content Object (operation 506), and incorporates the exclusion-rate factor into an overall factor F (operation 508). For example, the overall factor F can be a product of one or more factors {F₁, F₂, . . . Fₘ}.

To compute the exclusion-rate factor, a, the system first determines a number of exclusions, E, for the Content Object n|H(C) (hereinafter denoted as E_{n|H(C)}. The system can determine, E_{n|H(C)}, by determining a number of Interests that include an exclusion for n|H(C) (e.g., based on Interests the system has received for any Content Objects that include the name or name prefix n).

The system also determines a total number of requests, Qₙ, for Content Object C, (e.g., based on Interests received whose name include n, with or without the digest H(C)). The system can then compute the exclusion rate, R_{n|H(C)}, by computing:

R_{n|H(C)}=E_{n|H(C)}/Qₙ (1)

The system can then compute the exclusion-rate factor, α, by computing:

α=αₜ_{ₒ}−(R_{n|H(C)}×αₜ_{ₒ}) (2)

Note that in expression (2), the exclusion rate, a, depends on the exclusion rate at time tₒ (e.g., at the time the Content Object n|H(C) was added to the cache).

In some embodiments, the system can determine αₜ_{ₒ} based on a model for the ranking degradation pattern:

$${r}_{n \vert H ( C )} ( t ) = {e}^{\frac{- t}{α}} , where t ∈ [ 0 , {t}_{{t}_{o}} ] \qquad ( 3 )$$

In expression (3), t is the age of Content Object n|H(C) in the cache, and tₜ_{ₒ} is an elapsed time since the Content Object was added to the cache (e.g., content freshness). Hence, the system can compute αₜ_{ₒ} by computing:

$${r}_{{t}_{o}} = {e}^{\frac{- {t}_{o}}{{α}_{{t}_{o}}}} \qquad ( 4 )$$

In expression (4), rₜ_{ₒ} is the rank value assigned to the Content Object when it was added to the cache (e.g., the maximum rank value).

If the system is accounting for a time distribution (operation 510), the system computes an influence factor, iₙ|_{H(C)}(tₑ), for the Content Object (operation 512), and incorporates the influence factor into the overall factor F (operation 514). To compute the influence factor, iₙ|_{H(C)}(tₑ), the system can compute:

$${i}_{n \vert H ( C )} ( {t}_{e} ) = 1 - ( {e}^{\frac{- {t}_{e}}{β}} ) \qquad ( 5 )$$

In expression (5), tₑ designates an elapsed time since the last exclusion was received for the Content Object n|H(C), and β is a factor reflecting how fast the effect of the latest exclusion on the Content Object degrades over time.

In some embodiments, the influence factor has the range iₙ|_{H(C)}(tₑ) ε[0, 1], where iₙ|_{H(C)}(tₑ)=1 when the latest exclusion has a minimal effect on the Content Object's ranking. A larger fi requires more time to elapse before an exclusion has a minimal effect on the Content Object's ranking. Hence, a system administrator can preconfigure this maximum elapsed time as t_{mw}, and the system can compute β by setting t=t_{mw} and setting iₙ−_{H(C)}(tₑ)=1.

If the system is accounting for an excluding-interfaces ratio (operation 510), the system computes an excluding-interfaces factor, eₙ|_{H(C)}, for the Content Object (operation 512), and incorporates the excluding-interfaces factor into the overall factor F (operation 514). The system can compute the excluding-interfaces factor, eₙ|_{H(C)}, by computing:

$${e}_{n \vert H ( C )} = \{ \begin{matrix}\frac{{f}_{s} - {f}_{e}}{{f}_{s}} & if {f}_{s} \geq {f}_{e} \\ 1 & otherwise\end{matrix} \qquad ( 6 )$$

In expression (6), fₛ is the number of interfaces on which the router previously served the Content Object n|H(C), and has the range fₛε[0, fₙ], wherein fₙ is the total number of interfaces of the router. Also, fₑ is the number of interfaces on which the router received Interests that exclude the Content Object n|H(C), and has the range fₑε[1, fₙ]. In some embodiments, fₑ cannot have a value of zero because for ranking to exist, the router needs to have received an Interest for and have served the Content Object on at least one interface.

In some embodiments, eₙ|_{H(C)}ε[0, 1], wherein eₙ|_{H(C)}=1 indicates that the router has not received an exclusion for Content Object n|H(C). It is possible for fₑ to exceed fₛ, which can occur when the router receives an Interest that excludes the Content Object on an interface through which the router has not served the current instance of the Content Object n|H(C). This can occur, for example, due to routing changes across the network topology, when a client device that previously consumed the Content Object n|H(C) has moved to a new network location, and/or cache replacement of the Content Object. Cache replacement can occur when a previous instance of the Content Object n|H(C) was previously requested by a client, cached by the router (e.g., after forwarding the Interest to a publisher), and later flushed from the cache. Note that expression (6) caps the excluding-interfaces factor, eₙ|_{H(C)}, to 1 when fₑ>fₛ.

Once the system has accounted for the one or more selected exclusion patterns, the system computes the Content Object's rank value based on the overall factor, F (operation 522). For example, the system can compute the rank value by computing:

$${r}_{n \vert H ( C )} ( t ) = {e}^{\frac{- t}{F}} \qquad ( 7 )$$

In expression (7), t is the age of Content Object n|H(C) in the cache, and tₜ_{ₒ} is an elapsed time since the Content Object was added to the cache (e.g., content freshness).

For example, if the system is only accounting for the exclusion rate, then the overall factor F becomes:

F=α=αₜ_{ₑ}−(R_{n|H(C)}×αₜ_{ₒ}) (8)

Hence, the Content Object's rank becomes:

$${r}_{n \vert H ( C )} ( t ) = {e}^{\frac{- t}{{α}_{{t}_{o}} - ( {R}_{n \vert H ( C )} \times {α}_{{t}_{o}} )}} \qquad ( 9 )$$

As another example, if the system is accounting for the exclusion rate and the time distribution, then the overall factor F becomes:

$$\begin{matrix}F = {i}_{n \vert H ( C )} ( {t}_{e} ) \times α \\ = {i}_{n \vert H ( C )} ( {t}_{e} ) \times [ {α}_{{t}_{o}} - ( {R}_{n \vert H ( C )} \times {α}_{{t}_{o}} ) ]\end{matrix} \qquad ( 10 )$$

Hence, the Content Object's rank becomes:

$${r}_{n \vert H ( C )} ( t ) = {e}^{\frac{- t}{{i}_{n \vert H ( C )} ( {t}_{e} ) \times [ {α}_{{t}_{o}} - ( {R}_{n \vert H ( C )} \times {α}_{{t}_{o}} ) ]}} \qquad ( 11 )$$

Moreover, if the system is accounting for all three exclusion patterns (e.g., the exclusion rate, the time distribution, and the excluding-interfaces ratio), then the overall factor F becomes:

$$\begin{matrix}F = {e}_{n \vert H ( C )} \times {i}_{n \vert H ( C )} ( {t}_{e} ) \times α \\ = {e}_{n \vert H ( C )} \times {i}_{n \vert H ( C )} ( {t}_{e} ) \times [ {α}_{{t}_{o}} - ( {R}_{n \vert H ( C )} \times {α}_{{t}_{o}} ) ]\end{matrix} \qquad ( 12 )$$

Hence, the Content Object's rank becomes:

$${r}_{n \vert H ( C )} ( t ) = {e}^{\frac{- t}{{e}_{n \vert H ( C )} \times {i}_{n \vert H ( C )} ( {t}_{e} ) \times [ {α}_{{t}_{o}} - ( {R}_{n \vert H ( C )} \times {α}_{{t}_{o}} ) ]}} \qquad ( 13 )$$

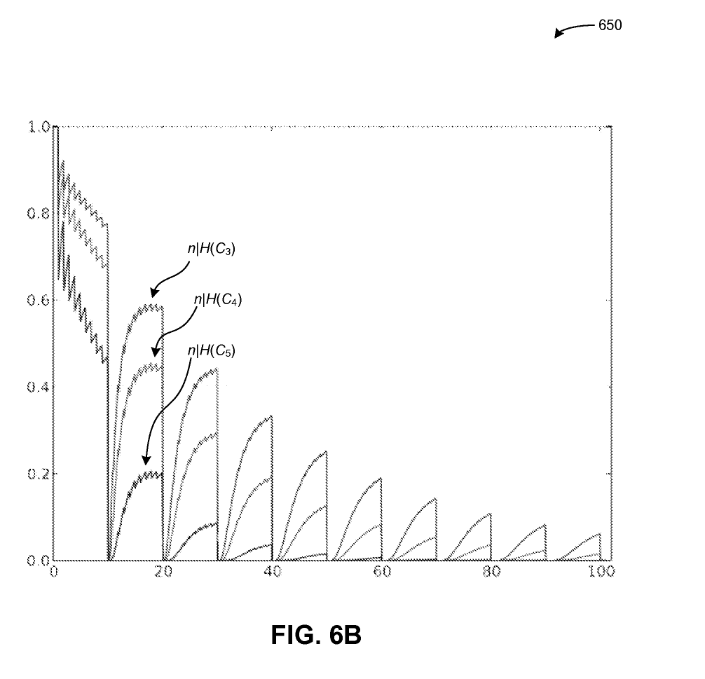

FIGS. 6A-6B illustrate rank values for a set of exemplary Content Objects in accordance with an embodiment. Specifically, FIGS. 6A and 6B illustrate ranking degradation patterns of five Content Objects with name n: n|H(C₁), n|H(C₂), n|H(C₃), n|H(C₄), and n|H(C₅). These rank-degradation patterns are a result of a router computing rank values according to expression (13), which accounts for exclusion rates for cached Content Objects, the time distribution of exclusions, and the excluding-interfaces ratio. Content Objects n|H(C₁), n|H(C₂), n|H(C₃), n|H(C₄), and n|H(C₅) receive exclusions according to Table 1.

TABLE 1

| Parameter | n\|H(C₁) | n\|H(C₂) | n\|H(C₃) | n\|H(C₄) | n\|H(C₅) |
|---|---|---|---|---|---|
| Content | C₁ | C₂ | C₃ | C₄ | C₅ |
| Name | n | n | n | n | n |
| Digest | H(C₁) | H(C₂) | H(C₃) | H(C₄) | H(C₅) |
| t | [0, 400], one sample every 100 msec | | | | |
| freshness | 400 | | | | |
| rₜₒ | 0.001 | | | | |
| Qₙ | 1 | 1 when t∈ [0, 50], and | increased by one every 10 sec | | |
| | | 2 when t∈ [50, 400] | | | |
| E_{n\|H(C)} | 0 | 1 when t∈ [0, 50], and | increased by one every 10 sec | | |
| | | 2 when t∈ [50, 400] | | | |
| t_{mw} | 400 | | | | |
| tₑ | ∞ | ∞ when t∈ [0, 50], and | [0, 10], increased by one every 1 sec, | | |
| | | increased by one ever 1 | and reset every 10 sec | | |
| | | sec when t > 50 | | | |
| fₙ | 4 | | | | |
| fₑ | 0 | 0 when t∈ [0, 50], and | 1 | 2 | 3 |
| | | 1 when t∈ [50, 400] | | | |

In some embodiments, a Content Object's ranking drops to a very low value (e.g., to zero, or near zero) when the router receives an exclusion for the Content Object, and the ranking increases again gradually according to the influence factor, iₙ|_{H(C)}(tₑ), of expression (5). For example, when t<=50 seconds in FIG. 6A, both n|H(C₁) and n|H(C₂) have equal ranking values, which are higher than the ranking values for Content Objects n|H(C₃), n|H(C₄), and n|H(C₅). However, the ranking of Content Object n|H(C₂) decreases more than that of n|H(C₁) at t=50 seconds, after the router receives an exclusion for n|H(C₂) via one interface. As another example, in FIG. 6B, the repetitive pattern of Content Objects n|H(C₃), n|H(C₄), and n|H(C₅) at 10 second intervals occurs because the router receives exclusions for these Content Objects every 10 seconds.

FIG. 6B also illustrates the effect of varying fₑ on the excluding-interfaces factor, eₙ|_{H(C)}, of expression (6). For example, the router receives exclusions for Content Object n|H(C₅) via three different interfaces, but receives the same number and rate of exclusions for Content Object n|H(C₃) via only one interface (and for n|H(C₄) via only two interfaces). Because the router receives exclusions for n|H(C₅) via more interfaces, the excluding-interfaces factor (eₙ|_{H(C)}) caused expression (6) to produce a lower rank value for Content Object n|H(C₅) than that of Content Objects n|H(C₃) and n|H(C₄).

Hence, FIGS. 6A and 6B illustrate that routers generally rank newer content higher than older content of the same name or name prefix. This configuration has the benefit of giving newer content a higher cache-read priority to allow this content to be distributed and disseminated in a timely manner. Moreover, in cases where there are none or few malicious consumers, the newer content is less likely to be fake. This is due to the fact that routers try to satisfy Interests from their caches whenever possible, and forward an Interest toward the content producer when matching content does not exist in the cache.

FIGS. 6A and 6B also illustrate that for as long as a router's cache contains a valid version of content, the router is likely to continue to serving this content over fake content. This remains true for as long as there are significantly more valid consumers than malicious consumers, which allows the router to typically rank the valid content higher than fake content. The router is not likely to receive enough exclusions for the valid content from enough interfaces to rank the valid content lower than that of fake content.

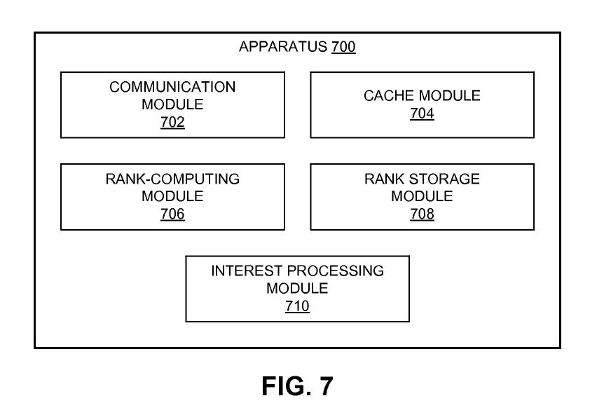

FIG. 7 illustrates an exemplary apparatus 700 that facilitates selecting a highest-ranking cached Content Object to satisfy an Interest in accordance with an embodiment. Apparatus 700 can comprise a plurality of modules which may communicate with one another via a wired or wireless communication channel. Apparatus 700 may be realized using one or more integrated circuits, and may include fewer or more modules than those shown in FIG. 7. Further, apparatus 700 may be integrated in a computer system, or realized as a separate device which is capable of communicating with other computer systems and/or devices. Specifically, apparatus 700 can comprise a communication module 702, a cache module 704, a rank-computing module 706, a rank storage module 708, and an Interest processing module 710.

In some embodiments, communication module 702 can receive and/or forward Interest messages and Content Objects over an information centric network, such as a named data network. Cache module 704 can cache Content Objects, and rank-computing module 706 can analyze exclusions received for a Content Object to compute a rank value for the Content Object. Rank storage module 708 can store the rank value in association with the Content Object. Interest processing module 710 can process an Interest by selecting, from one or more Content Objects whose name or name prefix includes the Interest's name, a Content Object which has a highest rank value, and returning this Content Object to satisfy the Interest.

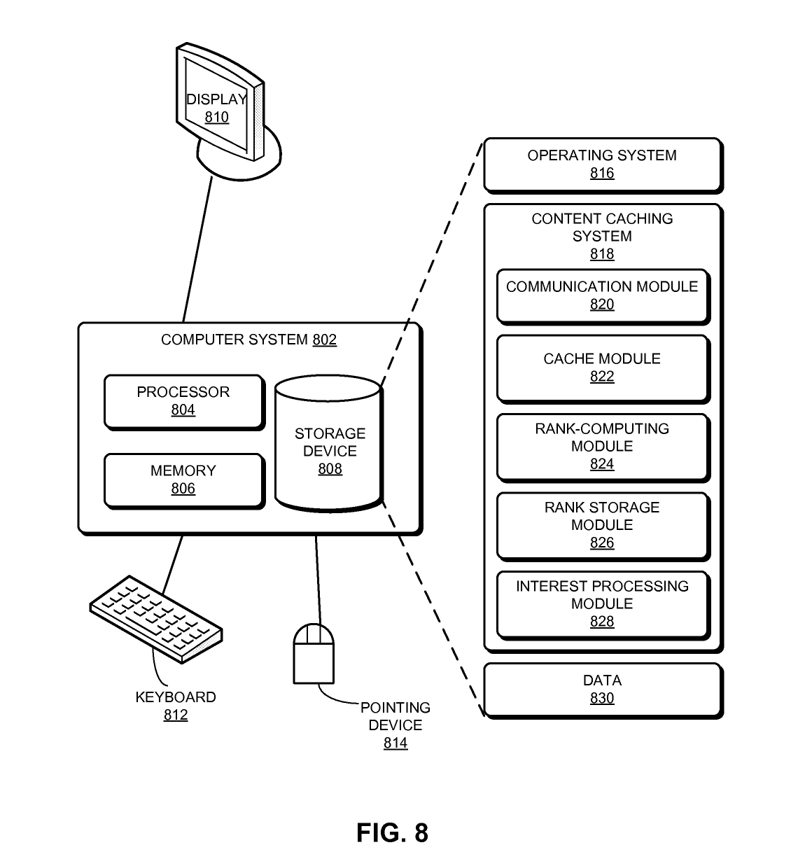

FIG. 8 illustrates an exemplary computer system 802 that facilitates selecting a highest-ranking cached Content Object to satisfy an Interest in accordance with an embodiment. Computer system 802 includes a processor 804, a memory 806, and a storage device 808. Memory 806 can include a volatile memory (e.g., RAM) that serves as a managed memory, and can be used to store one or more memory pools. Furthermore, computer system 802 can be coupled to a display device 810, a keyboard 812, and a pointing device 814. Storage device 808 can store operating system 816, content-caching system 818, and data 830.

Content-caching system 818 can include instructions, which when executed by computer system 802, can cause computer system 802 to perform methods and/or processes described in this disclosure. Specifically, content-caching system 818 may include instructions for receiving and/or forwarding Interest messages and Content Objects over an information centric network, such as a named data network (communication module 820). Further, content-caching system 818 can include instructions for caching Content Objects (cache module 822), and can include instructions for analyzing exclusions received for a Content Object to compute a rank value for the Content Object (rank-computing module 824).

Content-caching system 818 can include instructions for storing the rank value in association with the Content Object (rank storage module 826). Content-caching system 818 can also include instructions for processing an Interest by selecting, from one or more Content Objects whose name or name prefix includes the Interest's name, a Content Object which has a highest rank value, and returning this Content Object to satisfy the Interest (Interest processing module 828).

Data 830 can include any data that is required as input or that is generated as output by the methods and/or processes described in this disclosure. Specifically, data 830 can store at least a set of cached Content Objects, and a rank value for each cached Content Object.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
selecting a Content Object to rank;
analyzing, by a forwarding device, historical usage information for the Content Object;
determining, from the historical usage information, a set of exclusions received for the Content Object;
computing a rank value for the Content Object, based on the set of exclusions for the Content Object and one or more predetermined exclusion patterns; and
storing the rank value in association with the Content Object.

2. The method of claim 1, wherein the Content Object is a cached Content Object.

3. The method of claim 1, further comprising, selecting the Content Object to rank in response to one or more of:
storing the Content Object in a cache;
receiving an Interest whose name matches a name or name prefix of the Content Object; and
receiving an Interest that includes an exception for the Content Object.

4. The method of claim 1, further comprising:
receiving an Interest whose name is associated with multiple cached Content Objects;
selecting, from the multiple cached Content Objects, a cached Content Object with a highest rank value; and
returning the selected cached Content Object to satisfy the Interest.

5. The method of claim 1, further comprising:
determining that the Content Object is a new Content Object; and
assigning a maximum rank value to the Content Object.

6. The method of claim 5, wherein determining that the Content Object is a new Content Object involves one or more of:
determining that the Content Object has not been returned to satisfy an Interest; and
determining that an exclusion has not been received for the Content Object.

7. The method of claim 1, further comprising selecting one or more exclusion patterns for ranking the Content Object from a set of predetermined exclusion patterns including at least one of:
an exclusion-rate pattern that ranks the Content Object based on a rate at which the Content Object received exclusions;
a time distribution pattern that ranks the Content Object based on a time elapsed since the Content Object received an exclusion; and
an excluding-interfaces pattern that ranks the Content Object based on a fraction of local interfaces from which the Content Object received exclusions.

8. The method of claim 1, wherein computing the rank value involves:
computing a factor for each exclusion pattern, based on the set of exclusions for the Content Object;
computing an overall factor, F, based on the individual factors for each exclusion pattern; and
computing the rank value using the overall factor, F.

9. The method of claim 8, wherein computing the rank value further involves computing:
$${r}_{n \vert H ( C )} ( t ) = {e}^{\frac{- t}{F}}$$
wherein r_{n|H(C)} designates the rank value for the Content Object, and wherein t designates the age of the Content Object in the cache.

10. A non-transitory computer-readable storage medium storing instructions that when executed by a computer cause the computer to perform a method:
selecting a Content Object to rank;
analyzing, by a forwarding device, historical usage information for the Content Object;
determining, from the historical usage information, a set of exclusions received for the Content Object;
computing a rank value for the Content Object, based on the set of exclusions for the Content Object and one or more predetermined exclusion patterns; and
storing the rank value in association with the Content Object.

11. The storage medium of claim 10, further comprising, selecting the Content Object to rank in response to one or more of:
storing the Content Object in a cache;
receiving an Interest whose name matches a name or name prefix of the Content Object; and
receiving an Interest that includes an exception for the Content Object.

12. The storage medium of claim 10, further comprising:
receiving an Interest whose name is associated with multiple cached Content Objects;
selecting, from the multiple cached Content Objects, a cached Content Object with a highest rank value; and
returning the selected cached Content Object to satisfy the Interest.

13. The storage medium of claim 10, further comprising:
determining that the Content Object is a new Content Object; and
assigning a maximum rank value to the Content Object.

14. The storage medium of claim 13, wherein determining that the Content Object is a new Content Object involves one or more of:
determining that the Content Object has not been returned to satisfy an Interest; and
determining that an exclusion has not been received for the Content Object.

15. The storage medium of claim 10, further comprising selecting one or more exclusion patterns for ranking the Content Object, from a set of predetermined exclusion patterns including at least one of:
an exclusion-rate pattern that ranks the Content Object based on a rate at which the Content Object received exclusions;
a time distribution pattern that ranks the Content Object based on a time elapsed since the Content Object received an exclusion; and
an excluding-interfaces pattern that ranks the Content Object based on a fraction of local interfaces from which the Content Object received exclusions.

16. The storage medium of claim 10, wherein computing the rank value involves:
computing a factor for each exclusion pattern, based on the set of exclusions for the Content Object;
computing an overall factor, F, based on the individual factors for each exclusion pattern; and
computing the rank value using the overall factor, F.

17. The storage medium of claim 16, wherein computing the rank value further involves computing:
$${r}_{n \vert H ( C )} ( t ) = {e}^{\frac{- t}{F}}$$
wherein r_{n|H(C)} designates the rank value for the Content Object, and wherein t designates the age of the Content Object in the cache.

18. A computer system, comprising:
one or more processors;
a memory; and
a computer-readable medium coupled to the one or more processors storing instructions stored that, when executed by the one or more processors, cause the computing system to perform a method comprising:
selecting a Content Object to rank;
analyzing, by a forwarding device, historical usage information for the Content Object;
determining, from the historical usage information, a set of exclusions received for the Content Object;
computing a rank value for the Content Object, based on the set of exclusions for the Content Object and one or more predetermined exclusion patterns; and
storing the rank value in association with the Content Object.

19. The computer system of claim 18, further comprising, selecting the Content Object to rank in response to one or more of:
storing the Content Object in a cache;
receiving an Interest whose name matches a name or name prefix of the Content Object; and
receiving an Interest that includes an exception for the Content Object.

20. The computer system of claim 18, further comprising:
receiving an Interest whose name is associated with multiple cached Content Objects;
selecting, from the multiple cached Content Objects, a cached Content Object with a highest rank value; and
returning the selected cached Content Object to satisfy the Interest.

21. The computer system of claim 18, further comprising:
determining that the Content Object is a new Content Object; and
assigning a maximum rank value to the Content Object.

22. The computer system of claim 21, wherein determining that the Content Object is a new Content Object involves one or more of:
determining that the Content Object has not been returned to satisfy an Interest; and
determining that an exclusion has not been received for the Content Object.

23. The computer system of claim 18, further comprising selecting one or more exclusion patterns for ranking the Content Object, from a set of predetermined exclusion patterns including at least one of:
an exclusion-rate pattern that ranks the Content Object based on a rate at which the Content Object received exclusions;
a time distribution pattern that ranks the Content Object based on a time elapsed since the Content Object received an exclusion; and
an excluding-interfaces pattern that ranks the Content Object based on a fraction of local interfaces from which the Content Object received exclusions.

24. The computer system of claim 18, wherein computing the rank value involves:
computing a factor for each exclusion pattern, based on the set of exclusions for the Content Object;
computing an overall factor, F, based on the individual factors for each exclusion pattern; and
computing the rank value using the overall factor, F.

25. The computer system of claim 24, wherein computing the rank value further involves computing:
$${r}_{n \vert H ( C )} ( t ) = {e}^{\frac{- t}{F}}$$
wherein r_{n|H(C)} designates the rank value for the Content Object, and wherein t designates the age of the Content Object in the cache.
